(19) United States
(12) Patent Application Publication
(10) Pub. No.: US 2023/0325762 A1
(43) Pub. Date: Oct. 12, 2023

(54) METHODS AND SYSTEMS FOR DIGITAL PLACEMENT AND ALLOCATION

(71) Applicant: Target Brands, Inc., Minneapolis, MN (US)

(72) Inventors: VIVEK PAREPALLI, Bengaluru (IN); VIPIN JAWARIA, Bengaluru (IN); PRATIK CHAUDHARI, Bengaluru (IN); AFZAL SM, Bengaluru (IN); AARON RIEKENBERG, Minneapolis, MN (US); SANIL VEERAVU, Minneapolis, MN (US)

(21) Appl. No.: 17/715,733

(22) Filed: Apr. 7, 2022

(51) Int. Cl. G06Q 10/08; G06Q 10/06; G06Q 30/02

(52) U.S. Cl. CPC G06Q 10/087; G06Q 30/0202; G06Q 10/067

(57) ABSTRACT

Methods, systems, and platforms are described for digital placement and allocation planning. An unconstrained distribution of items in a retail supply chain may be determined from digital demand forecasts by aggregating the digital demand forecasts based on location identifiers. An item allocation ratio between shipping locations may be determined using a model based on items being ordered together and the speed of items being ordered. An unconstrained DPA plan may be generated, with the distribution and the ratio, for placing and allocating a projected total quantity. Constraints relating to the supply chain may be identified. In response to the constraints, a constrained distribution may be generated from an unconstrained distribution. A constrained plan may be generated in response to the constrained distribution. The unconstrained or constrained DPA plan may be sent to a plan executor for initiating movements of items according to the plan within the supply chain.

### TECHNICAL FIELD

The present application relates generally to supply chain management for retail and e-commerce, and in particular to methods and systems for generating digital placement and allocation (“DPA”) plans.

### BACKGROUND

With the rapid growth of online shopping and digital e-commerce, businesses have seen an increasing amount of digital orders and ship-to-consumer orders. To fulfill these orders, businesses often incur added cost of shipping packages to customers. The inefficiency in supply chain management, especially the placement and allocation of inventory, is a significant factor contributing to such excess cost.

A conventional approach in inventory placement and allocation is to map items, at the department level, to their default stocking locations. For example, in a large retail enterprise, a subset of items may be routed through a first warehouse to a first selection of stores, and a second (different) subset of items may be routed through a second warehouse, with some of those items retained at the warehouse, and other items routed to the same or a different selection of stores. The decisions regarding where items may be stocked can be based on historical sales levels for each individual item from retail locations. For online sales, another approach may be to place items as close to an intended sale as possible, in an attempt to reduce shipping costs. However, neither of these approaches captures true customer activity.

In view of the above and other disadvantages of existing systems, improvements are desirable.

### SUMMARY

In general, this patent document relates to a software service usable to generate recommendations regarding where an item should be stocked across various warehouses, as well as how much demand should be allocated to certain warehouses and stores. Businesses including retailers receive items at distribution centers, and ships items from distribution centers to warehouses for ultimate allocation to stores. Additionally, some items that are stocked at distribution centers and warehouses are not offered in stores, but instead are offered online. Their fulfillment is performed in response to digital orders. More specifically, this document relates to methods and systems for determining a digital placement and allocation (“DPA”) plan that places items often ordered together at a common location to reduce excess multiple package shipping scenarios, while locating items close to customers who will order such items.

In a first aspect, methods for generating DPA plans are disclosed. An example method includes receiving, from a demand forecasting system, digital demand forecasts for at least one item. The example method further includes determining a distribution of the item among a plurality of shipping locations by aggregating the digital demand forecasts based on a plurality of location identifiers, wherein the plurality of shipping locations include a plurality of warehouse locations and a plurality of retail locations. The example method further includes determining, via a model, a ratio of a first quantity of the item to a second quantity of the item, the first quantity of the item being configured to be allocated to the plurality of warehouse locations and the second quantity of the item being configured to be allocated to the plurality of retail locations, wherein the model is based on at least a first pattern of the item being ordered together with at least another item and a second pattern of the item being ordered at a certain speed. The example method further includes projecting a total quantity for the item, generating a plan for placing and allocating the total quantity of the item with the distribution and the ratio, and automatically sending the plan to a plan executor, the plan executor being configured to automatically initiate movements of at least a portion of the total quantity of the item among the plurality of shipping locations in accordance with the plan within a retail supply chain.

In a second aspect, systems for planning placement and allocation are disclosed. An example system includes an input device, a database, a data processing device in communication with the database, and an output device. The data processing device is configured to receive, from the input device, digital demand forecasts for at least one item. The data processing device is further configured to determine a distribution of the item among a plurality of shipping locations by aggregating the digital demand forecasts based on a plurality of location identifiers, wherein the plurality of shipping locations include a plurality of warehouse locations and a plurality of retail locations. The data processing device is further configured to determine, via a model, a ratio of a first quantity of the item to a second quantity of the item, the first quantity of the item being configured to be allocated to the plurality of warehouse locations and the second quantity of the item being configured to be allocated to the plurality of retail locations, wherein the model is based on at least a first pattern of the item being ordered together with at least another item and a second pattern of the item being ordered at a certain speed. The data processing device is further configured to project a total quantity for the item, generate a plan for placing and allocating the total quantity of the item with the distribution and the ratio, and automatically send, using the output device, the plan to a plan executor, the plan executor being configured to automatically initiate movements of at least a portion of the total quantity of the item among the plurality of shipping locations in accordance with the plan within a retail supply chain.

In a third aspect, platforms for planning placement and allocation are disclosed. An example platform includes a first and second computing devices, a plurality of data storages, and a network server in communication with the plurality of data storages, and with the first and second computing devices. The first computing device is configured to receive, from the network server, digital demand forecasts for at least one constrained item and information about the constrained item, the constrained item having at least one constraint relating to a retail supply chain. The first computing device is further configured to determine, in response to the constraint, a constrained distribution of the constrained item among a plurality of shipping locations by aggregating the digital demand forecasts based on a plurality of location identifiers, wherein the plurality of shipping locations include a plurality of warehouse locations and a plurality of retail locations. The first computing device is further configured to determine, via a model, a ratio of a first quantity of the constrained item to a second quantity of the constrained item, the first quantity of the constrained item being configured to be allocated to the plurality of warehouse locations and the second quantity of the constrained item being configured to be allocated to the plurality of retail locations, wherein the model is based on at least a first pattern of the constrained item being ordered together with at least another item and a second pattern of the constrained item being ordered at a certain speed. The first computing device is further configured to project a total quantity for the constrained item, generate a constrained plan for placing and allocating the total quantity of the constrained item with the constrained distribution and the ratio, and automatically send, via the network server, the constrained plan to the second computing device, the second computing device being configured to automatically initiate movements of at least a portion of the total quantity of the constrained item among the plurality of shipping locations in accordance with the constrained plan within a retail supply chain.

Other objects and advantages of the invention will be apparent to one of ordinary skill in the art upon reviewing the detailed description of the invention.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a schematic diagram illustrating an example supply chain network in which aspects of the present disclosure may be implemented.

FIG. 2 is a schematic block diagram illustrating an example supply chain management system, in accordance with an embodiment.

FIG. 3 is a flow chart illustrating an example method for generating a digital placement and allocation plan, in accordance with an embodiment.

FIG. 4 is a schematic block diagram illustrating an example digital placement and allocation planning system, in accordance with an embodiment.

FIG. 5 is a flow chart illustrating an example method for determining a node distribution index.

FIG. 6 is a flow chart illustrating an example method for generating order profile forecasts.

FIG. 7 is an example table illustrating a portion of example data of order profile forecasts.

FIG. 8 is an example table illustrating a portion of example data of items clustering.

FIG. 9 is an example table illustrating a portion of example data of projected total quantity numbers for items.

FIG. 10 is a flow chart illustrating an example method for generating a constrained node distribution index.

FIG. 11 illustrates example tables showing example results of generating a constrained node distribution index in response to constraints regarding supply chain.

FIG. 12 is a flow chart illustrating an example method for generating a constrained node distribution index in response to capacity constraints of shipping locations.

FIG. 13 is a flow chart illustrating an example method 1300 for iteratively solving nested and multiple constraints regarding supply chain.

FIG. 14 illustrates an example computing system on which aspects of the present disclosure may be implemented.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

For purposes of this patent document, the terms “or” and “and” shall mean “and/or” unless stated otherwise or clearly intended otherwise by the context of their use. Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” “including,” “having,” and “has” are interchangeable and not intended to be limiting. The term “such as” also is not intended to be limiting. For example, the term “including” shall mean “including, but not limited to.”

All ranges provided herein include the upper and lower values of the range unless explicitly noted. Although values are disclosed herein when disclosing certain exemplary embodiments, other embodiments within the scope of the pending claims can have values other than the specific values disclosed herein or values that are outside the ranges disclosed herein.

Terms such as “substantially” or “about” when used with values or structural elements provide a tolerance that is ordinarily found during testing and production due to variations and inexact tolerances in factor such as material and equipment.

Generally speaking, the present disclosure relates to systems and methods for generating digital placement and allocation (“DPA”) plans for various stocking and shipping locations along multiple levels of the supply chain. In particular, the present disclosure relates to planning and recommendations regarding where an item should be stocked across various, geographically distributed warehouses, as well as how much demand should be allocated to particular retail locations. Because the systems and methods described herein enable planning for items placement and allocation based on customer demand forecasts, the overall system described herein generates and effectuates an optimized plan to reduce shipping expense. In some instances, a retail enterprise with the system described herein may reduce shipping costs by reducing an overall number of packages shipped. That is, the DPA plans described herein may, in some instances recommend placement of items often ordered together at a common location to reduce the likelihood that a digital order will result in shipment of multiple packages, while also placing items at a warehouse or retail location close to customers who will order such items.

In example implementations, the DPA planning systems described herein can, because they are designed and implemented to be cognizant of digital fulfillment channels of a retail enterprise and consumer demand forecasts at item level, generate DPA plans at a very high level of accuracy and granularity. For example, the methods and systems described herein not only account for what stores have in stock, but also consider various fulfillment channels with a focus on digital orders and ship-to-home orders. As a result, a more efficient allocation of items can be achieved, resulting in fewer extraneous item movements, more consolidated shipments, and therefore reduced overall shipping expense. Furthermore, because such added shipments not only increase expense, but also increase time to customer and increase a number of inventory movement events tracked within a supply chain, a more intelligently-planned DPA plan will reduce overall computational and labor burden within supply chain systems of a retail enterprise as well.

In another embodiment, the DPA planning methods and systems described herein adopt a modeling approach by collecting and aggregating historical digital sales data. Such an approach further improves the accuracy and efficiency of the process to generate DPA plans that account for consumer demand.

Still further, it can be non-advantageous to generate DPA plans without considering various constraints across all stocking and shipping locations. For example, a warehouse may be exhausted of capacity if too many items are allocated to it due to its vicinity to large volumes of expected consumer demand. Further examples include certain limitations of locations within a retail supply chain being unable to handle certain types of items. In example embodiments, the DPA planning methods and systems described herein account for various constraints to generate constrained DPA plans that are optimized within bounds of any constraints that may apply to a given retail supply chain.

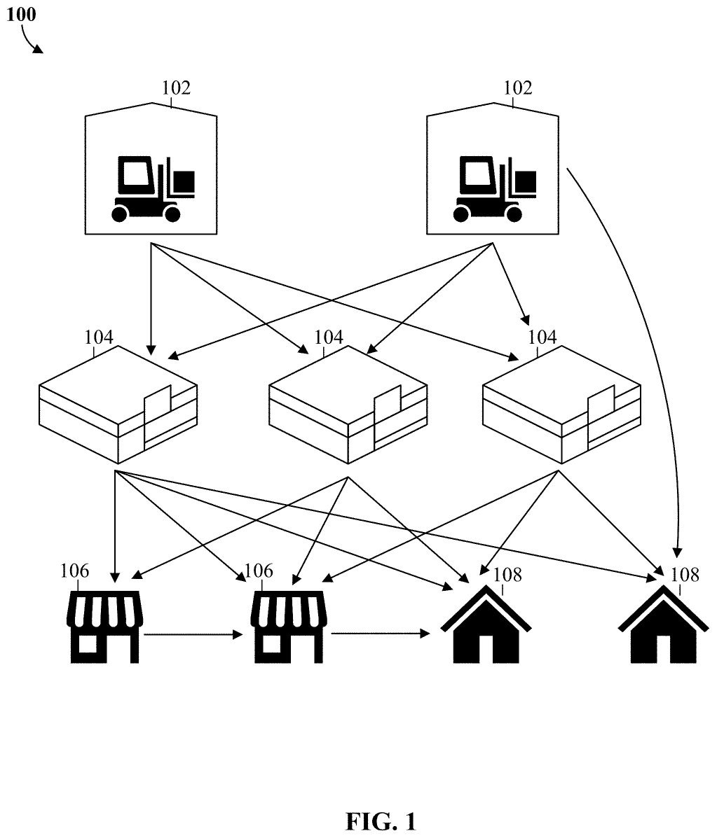

Referring first to FIG. 1, an example of multi-level supply chain network 100 in which aspects of the present disclosure may be implemented is shown. In the example supply chain network 100, a plurality of distribution centers 102 are locations at which items are received from vendors, and from which items are distributed in pallets or other volumes to a plurality of warehouses 104. After items are received at the warehouses 104, they can be disassembled to smaller batches and further distributed to a plurality of retail locations 106. In some embodiments, orders can be shipped to a particular retail location for pickup. Accordingly, ordered items can be shipped from the warehouses 104 or another one of the retail locations 106. In other embodiments, items ordered by customers can be shipped directly to home locations 108 from the distribution centers 102, the warehouses 104, or the retail locations 106, depending on circumstances.

In the example supply chain network 100, for each of the warehouses 104 and the retail locations 106, the amount of a certain item to be allocated to the location needs to be determined for a certain time frame. A placement plan is required for such determination. Furthermore, an allocation plan is required for fulfilling digital ship-to-home orders to determine the percentage of the total ordered items that will be shipped from the warehouses 104 and the percentage that will be shipped from the retail locations 106. Generally speaking, it's advantageous to ship from locations that are geographically close to the ordering customers, and to ship items within a single order from the least number of different locations.

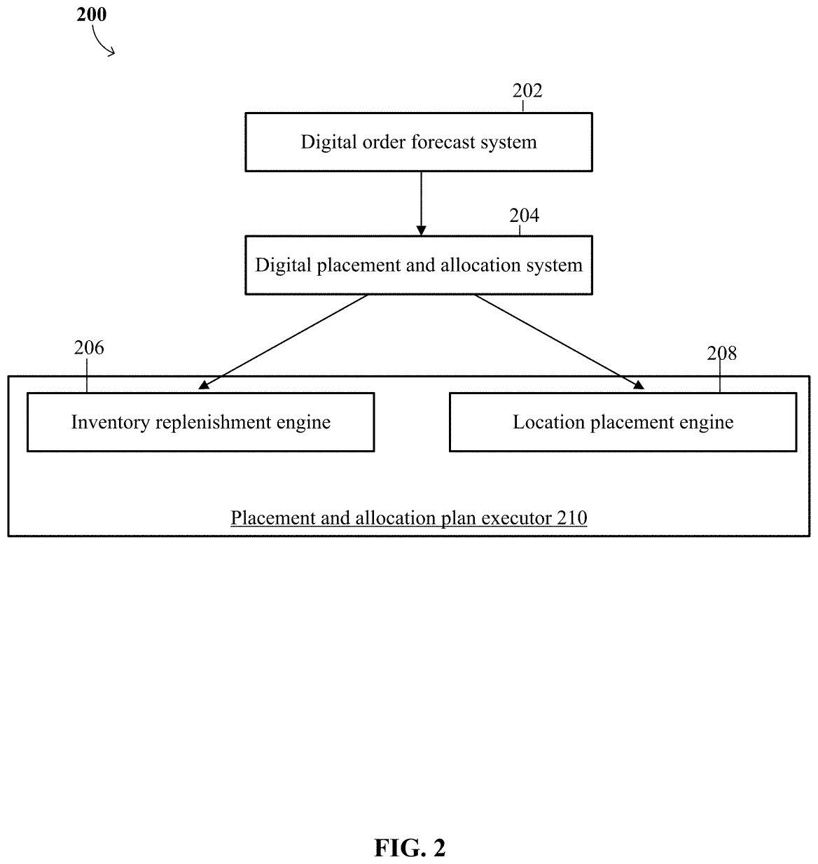

FIG. 2 is a schematic block diagram depicting an example supply chain management system 200. The example supply chain management system 200 includes a digital order forecast system 202, a digital placement and allocation system 204, and a placement and allocation plan executor 210. In some examples, the allocation plan executor 210 includes an inventory replenishment engine 206 and a location placement engine 208.

The digital order forecast system 202 is operable to generate item forecasts corresponding to digital order demand from consumers and provide the item forecasts to the digital placement and allocation (“DPA”) system 204. Examples of the information contained in the item forecasts include predictive estimates about ordered items, quantity of ordered items, time frame, and location of customer, etc. In some embodiments, the digital order forecast system can be a demand forecasting engine.

With the received item forecasts, the DPA system 204 is operable to generate a DPA plan including placement recommendations and allocation recommendations. The DPA system in this illustrated example is operable to send the placement recommendations to the location placement engine 208 of the allocation plan executor 210 informing the quantity of a certain item configured to be allocated to certain shipping locations (for instance, the warehouses 104 illustrated in FIG. 1). In some examples, the location placement engine 208 is a warehouse placement engine and the placement recommendations sent by the DPA system 204 only include information for the warehouses 104.

The DPA system 204 is also operable to send the allocation recommendations to the inventory replenishment engine 206 of the allocation plan executor 210 informing the percentage of the total ordered items that will be shipped from the warehouses 104 and the percentage that will be shipped from the retail locations 106 within a given time frame. The inventory replenishment engine 206 is configured to manage inventory movement to shipping locations according to the allocation recommendations from the DPA system 204.

The inventory replenishment engine 206 and the location placement engine 208 are both operable to automatically initiate movements of the ordered items among multiple shipping locations in accordance with the DPA plan within the supply chain network 100.

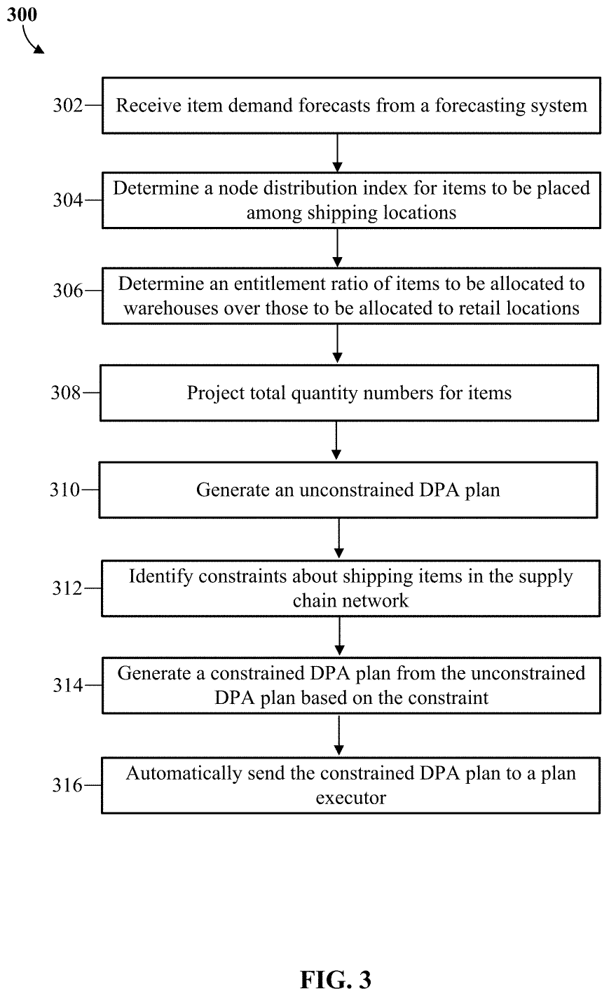

Referring to FIG. 3, a flow chart is shown to illustrate an example method 300 for generating a digital placement and allocation plan. In some examples, the example method 300 is operated with the DPA system 204. In the illustrated example, the method 300 includes steps 302, 304, 306, 308, 310, 312, 314, 316. In various embodiments, the steps 304, 306, and 308 can be configured to be performed in any order.

In the example shown, the method 300 includes receiving item demand forecasts from a forecasting system (step 302), and determining a node distribution index for inventory items to be placed among multiple shipping locations in the supply chain network (step 304). For instance, a forecasted total quantity of an item representing consumer demand for the item is received first. Then, the forecasted total quantity is divided and placed to multiple shipping locations. The method 300 further includes determining an entitlement ratio of items to be allocated to warehouses over those to be allocated to retail locations (step 306). For instance, the portion of the total inventory of an item that is allocated to warehouses will be shipped from warehouses when ordered digitally by customers and the portion that is allocated to retail locations will be shipped from retail locations. In some examples, the entitlement ratio is in the form of an order profile forecast. To determine the entitlement ratio, a model is generated based on patterns regarding certain items that are more likely to be ordered together by customers, and patterns regarding certain items that are often ordered from certain locations at a certain speed. The method 300 further includes projecting total ownership numbers of the quantity of items across the supply chain network within a certain timeframe (step 308). As such, the total ownership numbers of items are identified in preparation of being placed and allocated across the supply chain network.

The method 300 further includes generating, using the node distribution index from the step 304, the entitlement ratio from the step 306, and the total ownership numbers of quantity from the step 308, an unconstrained DPA plan including placement and allocation recommendations (step 310). For instance, combining the total ownership numbers of quantity and the node distribution index provides sufficient information for the placement recommendations. Combining the total ownership numbers of quantity and the entitlement ratio provides sufficient information for the allocation recommendations. In some other embodiments, the DPA system 204 is configured to automatically send the unconstrained DPA plan to a plan executor (for instance, the placement and allocation plan executor 210).

In the example illustrated by FIG. 3, the DPA system 204 is configured to further account for constraints regarding how certain items can or cannot be processed and handled at certain shipping locations. The method 300 further includes identifying constraints about shipping certain items in the supply chain network (step 312). For instance, some items may be too bulky or too heavy to be processed at some warehouses and retail locations. In other examples, some warehouse may be geographically close to a large quantity of consumer demands, which can exceed the warehouse's inventory capacity. Examples of constraints in the supply chain network include building constraints, item constraints, item inclusions or exclusions, and business constraints, etc. Based on the identified constraints, the method 300 further includes generating a constrained DPA plan from the unconstrained DPA plan (step 314), and automatically sending the constrained DPA plan to a plan executor (step 316). For instance, the constrained DPA plan can be automatically sent to the placement and allocation plan executor 210.

In further embodiments, the example method 300 is configured to bypass the generation of the unconstrained DPA plan and directly generate the constrained DPA plan by first determining a constrained node distribution index based on identified constraints. In other examples, the example method 300 is configured to first determine an unconstrained node distribution index. Then, the example method 300 is configured to determine the constrained node distribution index based on identified constraints and generate the constrained DPA plan, without generating the unconstrained DPA plan.

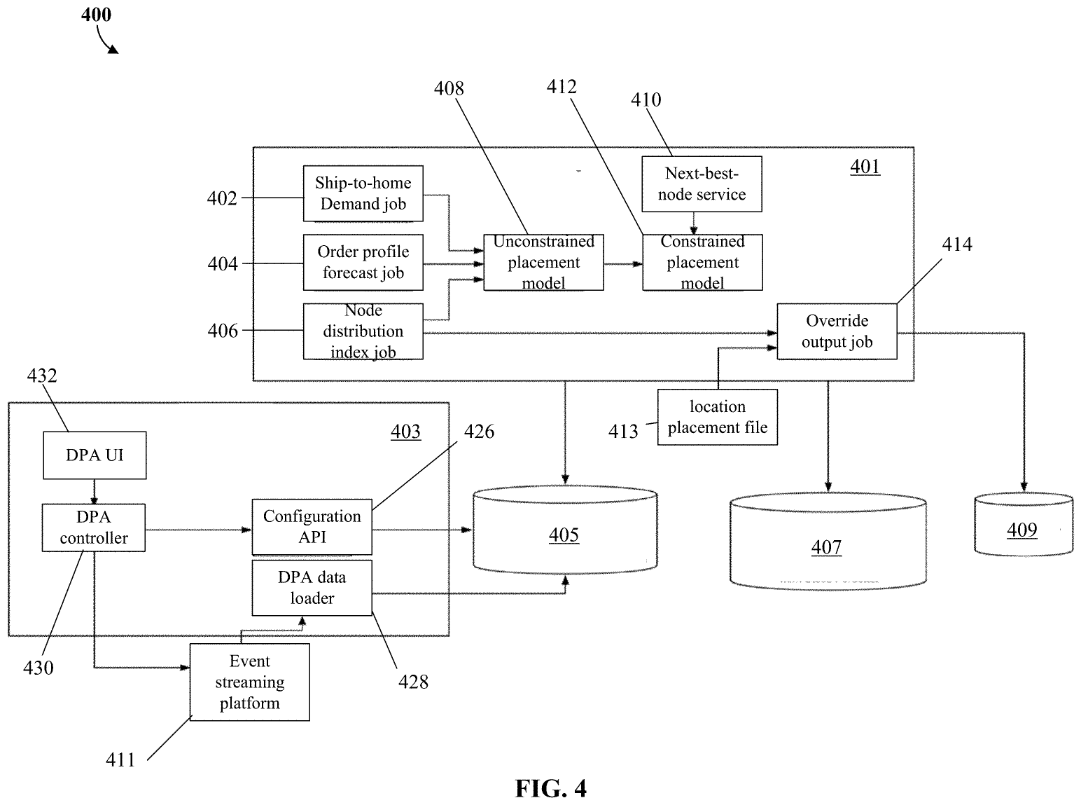

FIG. 4 is a schematic block diagram illustrating the architecture of an example DPA system 400. In this illustrated example, the DPA system 400 includes a job processing system 401, a DPA interface system 403, and data storage systems 405, 407, and 409. Also shown in FIG. 4 are an event streaming platform 411 and a location placement file 413. The job processing system 401 is operable to perform the generation of a DPA plan (for instance, the example method 300 illustrated and described in FIG. 3) by taking as input a location placement file and outputting an override file to the data storage system 409 for a plan executor device to implement. The job processing system 401 is configured to store and update data about items in, for instance, the data storage system 407. Examples of the data about items include historical demand data, item data, unconstrained placement forecast, constrained placement forecast, and item sales forecast, etc.

The DPA interface system 403 is configured to enable users to manage the operation of the DPA system 400 using the event streaming platform 411. In some examples, the event streaming platform 411 is a Kafka distributed streaming platform that enables the development of real-time, event-driven applications. The event streaming platform 411 and the job processing system 401 are both configured to store and update planning data in, for instance, the data storage system 405. Examples of the planning data include weeks of supply, warehouse entitlement rules, constraints, and item location inclusion/exclusion, etc.

In various embodiments, the data storage systems 405, 407, and 409 can be configured to store other types of data. In some examples, the data storage system 409 is a Hadoop distributed file system or other types of distributed file system. In other examples, the data storage system 407 is a Hive file system, which is a declarative SQL based language, mainly used for data analysis and creating reports. In yet further examples, the data storage 405 is a Postgres data storage, which is a relational database management system (“RDBMS”) compatible with SQL.

In this illustrated example, the job processing system 401 includes a ship-to-home demand job 402, an order profile forecast job 404, a node distribution index job 406, an unconstrained placement model 408, a next-best-node service 410, a constrained placement model 412, and an override output job 414. The ship-to-home demand job 402 is configured to process ship-to-home order demand forecasts including items, quantities, and locations from which orders are made within a certain timeframe.

The order profile forecast job 404 is configured to determine the entitlement ratio of items to be allocated to warehouses over those to be allocated to retail locations. For instance, the portion of the total inventory of an item that is allocated to warehouses will be shipped from warehouses when ordered digitally by customers and the portion that is allocated to retail locations will be shipped from retail locations. In some embodiments, to determine the ratio, a model is generated by collecting past digital sales data and item data (for instance, a last three years of sales data), and aggregating the data to generate a historical distribution of order profiles based on item types. In further embodiments, an item clustering operation uses algorithms like K++-means clustering algorithm or other algorithms to identify item clusters. The item clusters may include a sales velocity cluster (for instance, items that are often sold from a particular location) as well as an order profile cluster (based on a percentage share of order profiles). The order profile clustering reflects patterns of some certain items being ordered together more often. Common attributes of the clusters may then be used to assign item data to a particular cluster. An order profile forecast may then be generated with the model using algorithms like Auto ARIMA with manual seasonal differencing algorithm or other algorithms.

The node distribution index job 406 is configured to determine the node distribution index that maps items to certain shipping locations with certain percentages. In some examples, the node distribution index job 406 aggregates a last year of ship-to-home demand by location identifiers (for instance, ZIP Code), with each location identifier mapped to a closest shipping location. In other examples, the historical demand is further grouped along a number of hierarchies (for instance, item, class, department, group).

The unconstrained placement model 408 is configured to generate the unconstrained DPA plan using outputs of the ship-to-home demand job 402, the order profile forecast job 404, and the node distribution index job 406. The next-best-node service 410 is configured to solve constraints regarding shipping certain items among certain shipping locations in the supply chain network. Using the solution of the next-best-node service 410, the constrained placement model 412 is configured to generate the constrained DPA plan from the unconstrained DPA plan supplied by the unconstrained placement model 408. The override output job 414 is configured to take the results from the node distribution index job 406 and output an override file to the data storage 409 based on overriding the location placement file 413.

In some embodiments, the entirety of the job processing system 401 is configured to be operated and executed on a single computing device and a single memory device. In other embodiments, the job processing system 401 is configured to be operated and executed on a distributed computing environment comprising at least one network server, multiple computing devices, memory devices, and data storages. The network server is configured to be in communication with other components of the distributed computing environment. The components 402, 404, 406, 408, 410, 412, and 414 can be configured to be operated and executed on any combination of the multiple computing devices and memory devices. The components 402, 404, 406, 408, 410, 412, and 414 can be configured to be operated and executed in a number of different sequential or parallel orders.

The DPA interface system 403 includes a configuration application programming interface (“API”) 426, a DPA data loader 428, a DPA controller 430, and a DPA user interface (“UP”) 432. The configuration API 426 is configured to be controlled by the DPA controller 430 directly, while the DPA data loader 428 is configured to be controlled by the DPA controller 430 indirectly through the event streaming platform 411, which can utilize its own APIs. The DPA controller 430, in turn, is configured to take inputs from the DPA UI 432. In some embodiments, the DPA interface system 403 is configured to be operated and executed on the same computing device as the job processing system 401 or a component of the job processing system 401. In other embodiments, the DPA interface system 403 is configured to be operated and executed on a separate computing device in a distributed computing environment. In further embodiments, the example DPA system 400 includes multiple instantiations of the DPA interface system 403, the multiple instantiations being configured to be operated and executed on a single computing device or in a distributed computing environment.

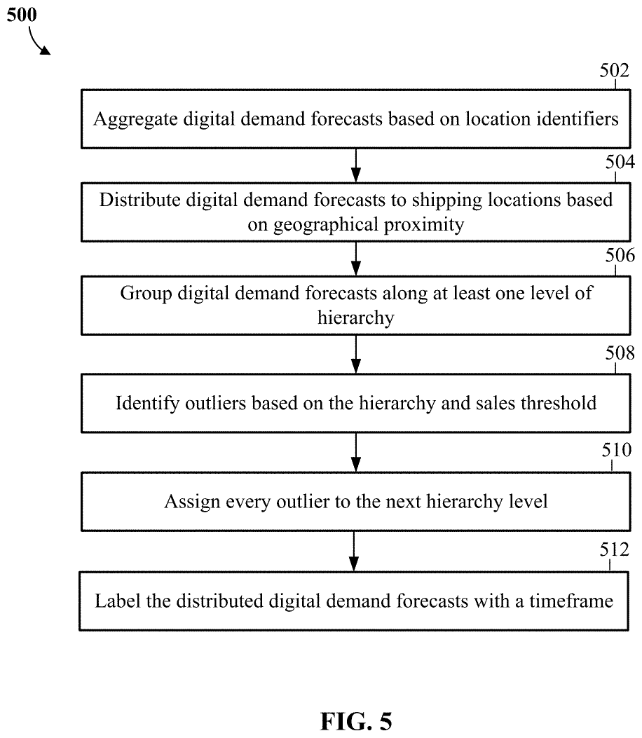

FIG. 5 is a flow chart illustrating an example method 500 for determining a node distribution index (described in FIG. 3), in accordance with an embodiment. In some examples, the method 500 is performed by the node distribution index job 406 (illustrated and described in FIG. 4). In this illustrated example, the example method 500 includes steps 502, 504, 506, 508, 510, and 512.

In the example as shown, the method 500 includes aggregating digital demand forecasts by location identifiers (for instance, ZIP Code) (step 502). For instance, the digital demand forecasts can be a last year of ship-to-home demand. The method 500 further includes distributing digital demand forecasts to shipping locations based on geographical proximity, with portions of digital demand forecasts grouped under each location identifier mapped to a geographically closest shipping location (step 504). For example, the ship-to-home ZIP codes aggregated in step 502 may be assigned to one or more warehouse or retail location shipping locations based on proximity.

In the example shown, the method 500 further includes grouping digital demand forecasts along a number of hierarchies (for instance, item, class, department, group) (step 506). Item outliers are then identified (step 508), for example based on the hierarchy levels and sales threshold levels. Item outliers may be items having sales threshold levels below a predetermined level, or which would otherwise be unpredictable for purposes of item placement. Each outlier may then be assigned to the next hierarchy level based on the grouping hierarchy (step 510). For instance, an item level outlier may be assigned to class level, and a class level outlier may be assigned to department level.

In the example shown, the method 500 further includes labeling the digital demand forecasts that have been distributed with a timeframe (for instance, weeks, quarters, or years, etc.) (step 512). As planned by the example method 500, inventory items are configured to be placed in shipping locations (for instance, the warehouses 104) that are geographically the closest to customers who are more likely to order them. Relying on the digital demand forecasts, shipping costs can be reduced.

In other embodiments, the method 500 can be configured to skip steps 506, 508, and 510 to determine a node distribution index without organizing items in levels of hierarchy. As such, the digital demand forecasts are configured to be distributed at granular item level for a certain timeframe.

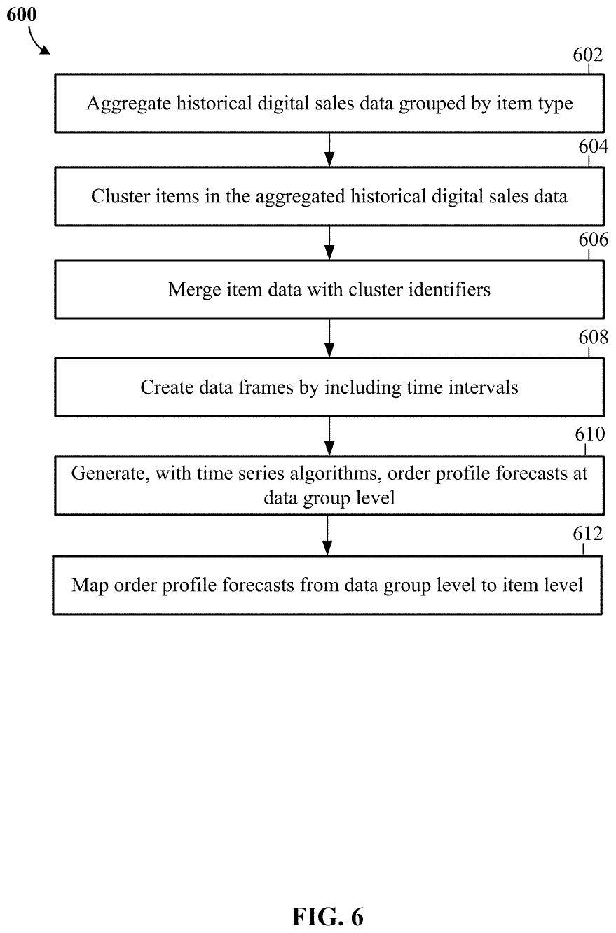

FIG. 6 is a flow chart illustrating an example method 600 for determining order profile forecasts with a model (described in FIG. 3), in accordance with an embodiment. In some examples, the example method 600 is performed by the order profile forecast job 404 (illustrated and described in FIG. 4). The example method 600 is configured to determine, for each inventory item, the percentage of the overall ship-to-home crossover demand from consumers that should be allocated to be shipped from the warehouses 104 and the percentage to be shipped from the retail locations 106 (illustrated and described in FIG. 1), respectively. With these percentages, the DPA planning as described herein can achieve better flexibility based on consumer ordering behaviors including patterns regarding certain items that are more likely to be ordered together and patterns regarding certain items that are often ordered from certain locations at a certain speed. In this illustrated example, the example method 600 includes steps 602, 604, 606, 608, 610, and 612.

In the example shown, the method 600 includes initiating the generation of a model by aggregating historical digital sales data (for example, last three years of sales data), and grouping the data based on item types (step 602). The aggregated data includes whether the ordered items have been shipped to home of consumers, or to retail locations like stores. Examples of the item types include pure crossover, pure store-only, pure online-only, crossover/store-only, crossover/online-only, online-only/store-only, and crossover/online-only/store-only.

The method 600 further includes clustering of items in the aggregated historical digital sales data (step 604). The item clusters include a sales velocity cluster tracking patterns regarding items that are often sold from a particular location at certain speed as well as an order profile cluster based on a percentage share of order profiles which tracks patterns regarding items that are often ordered together. The step 604 can be configured to use, for example, a K++-Means clustering algorithm or other algorithms to identify item clusters. The step 604, with clustering, is also configured to reduce the landscape of items data so that time series algorithms operating on the data will run more effectively and efficiently.

In the example shown, the method 600 further includes merging item data with cluster identifiers by assigning item data to clusters using common attributes of the clusters (step 606). Examples of the common attributes of the clusters include sales velocity, which tracks how often an item is sold, and order profile, which tracks what items are often ordered together. Other common attributes may be used as well. The method 600 further includes creating data frames that are suitable for time series algorithms by including time intervals (step 608). For instance, a data frame created by performing steps 606 and 608 can consist of items grouped by accounting week, year, sales velocity clusters, order profile cluster, and item selling channel. The data frames are configured to organize contiguous data for each data group, which is a pre-requisite characteristic for time series algorithms to run.

In the example shown, the method 600 further includes generating order profile forecasts using time series algorithms (step 610). Various types of time series algorithms can be implemented for the modeling of the example method 600. Based on efficiency of operation and quality of results measured during the development phase, some types of algorithms may be superior to other types for the application described herein. For example, Auto ARIMA with manual seasonal differencing algorithm is better than other types of models for the data patterns required by the DPA system and method described herein. The order profile forecasts generated by performing the step 610 are at data groups level. Furthermore, the method 600 includes mapping the order profile forecasts from data group level to item level (step 612). As such, allocations of overall ship-to-home demand for items are determined at individual item level, which improves flexibility for planning based on order profiles.

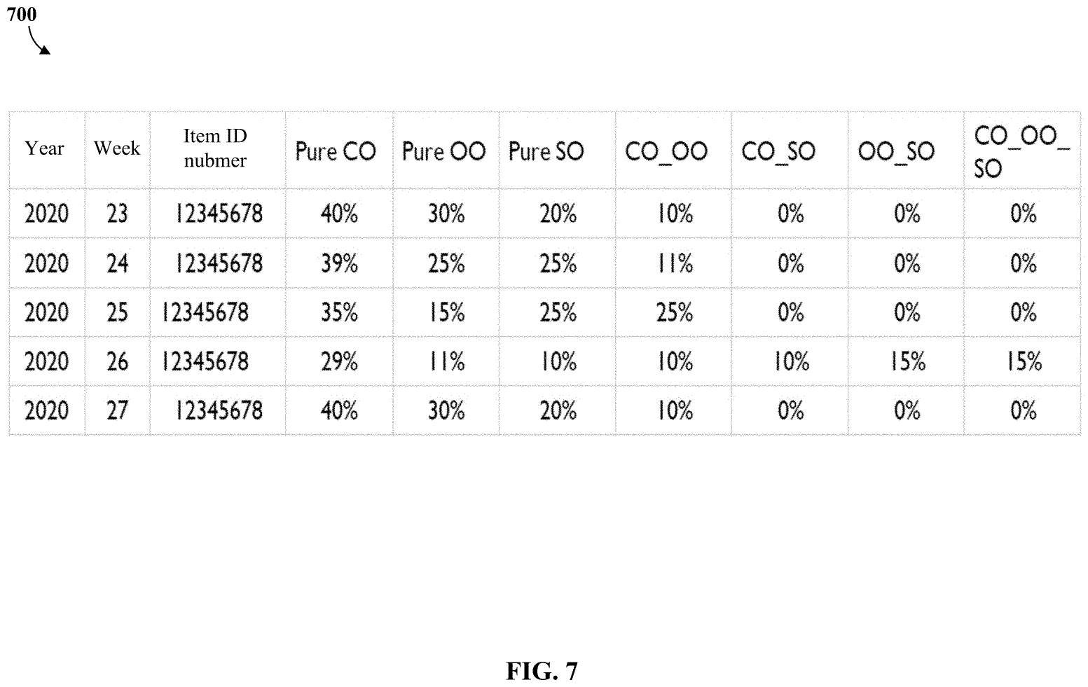

Referring to FIG. 7, an example table 700 illustrates a portion of example data of order profile forecasts (illustrated and described in FIG. 3, FIG. 4, and FIG. 6). In some embodiments, the example table 700 can be generated by performing the example method 600 (illustrated and described in FIG. 6). In this illustrated example table 700, each data entry is organized to include timeframe data of year in the first column, and week in the second column. The third column is for data of an item identification (“ID”) number. The rest of the columns are recorded with the percentages of overall digital hip-to-home order demand of seven example order types, respectively. The seven example order types, as illustrated, are pure crossover (“pure CO”), pure online-only (“pure OO”), pure store-only (“pure SO”), crossover/online-only (“CO_OO”), crossover/store-only (“CO_SO”), online-only/store-only (“OO_SO”), and crossover/online-only/store-only (“CO_OO_SO”) (described in FIG. 6). The example table 700 illustrates, for a certain item in a certain week of a certain year, the percentages of different order types among the total order quantity according to a DPA plan. Based on data as illustrated by the example table 700, allocation recommendations can be made for a supply chain network.

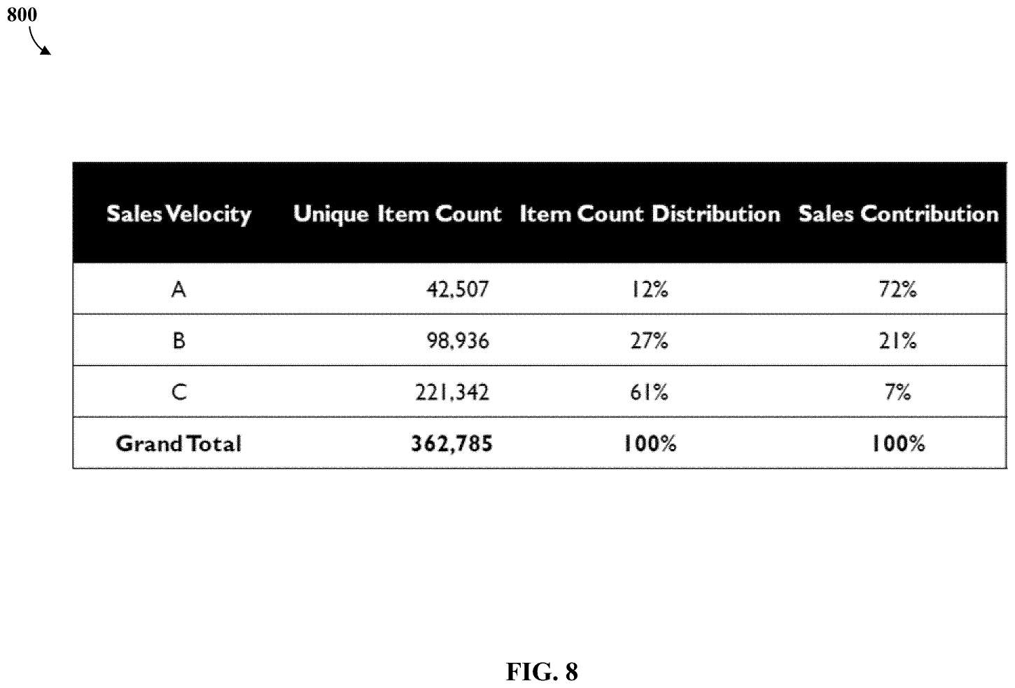

Referring to FIG. 8, an example table 800 illustrates a portion of example data showing intermediate results of items clustering based on sales velocity (described in FIG. 3, FIG. 4, and FIG. 6). In some embodiments, the example table 800 can be generated by performing the step 604 of the example method 600 (illustrated and described in FIG. 6). The illustrated example table 800 includes four columns. Sales velocity classifications in the first column illustrates how items are clustered based on sales velocity into three clusters in this example. Data about unique item count in the second column illustrates the quantity of unique items of the three clusters. Data about item count distribution in the third column illustrates the percentages of total items quantity for the three clusters. Data about sales contribution in the fourth column illustrates the percentages of total sales amount for the three clusters. The example table 800 also includes a grand total row configured to sum up all sales velocity classifications.

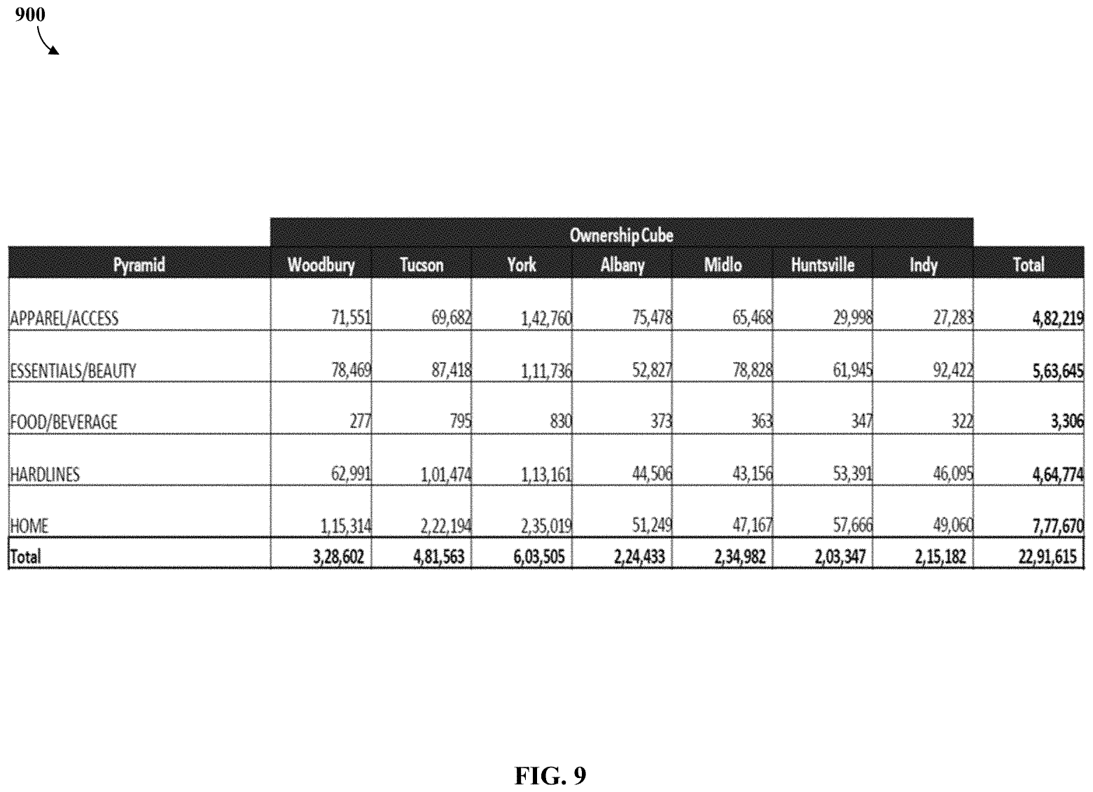

Referring to FIG. 9, an example table 900 illustrates a portion of example data of projected total quantity numbers for items (described in FIG. 3). In some embodiments, the example table 900 can be generated by performing the step 308 of the example method 300 (illustrated and described in FIG. 3). The illustrated example table 900 includes columns organized by different shipping locations and rows organized by classification of items. The example table 900 also includes a total row configured to sum up the total quantity of items across all item classifications for each shipping location, a total column configured to sum up the total quantity of items across all shipping locations for each item classification, and a grand total data filed configured to sum up the total quantity of items across all shipping locations and across all item classifications.

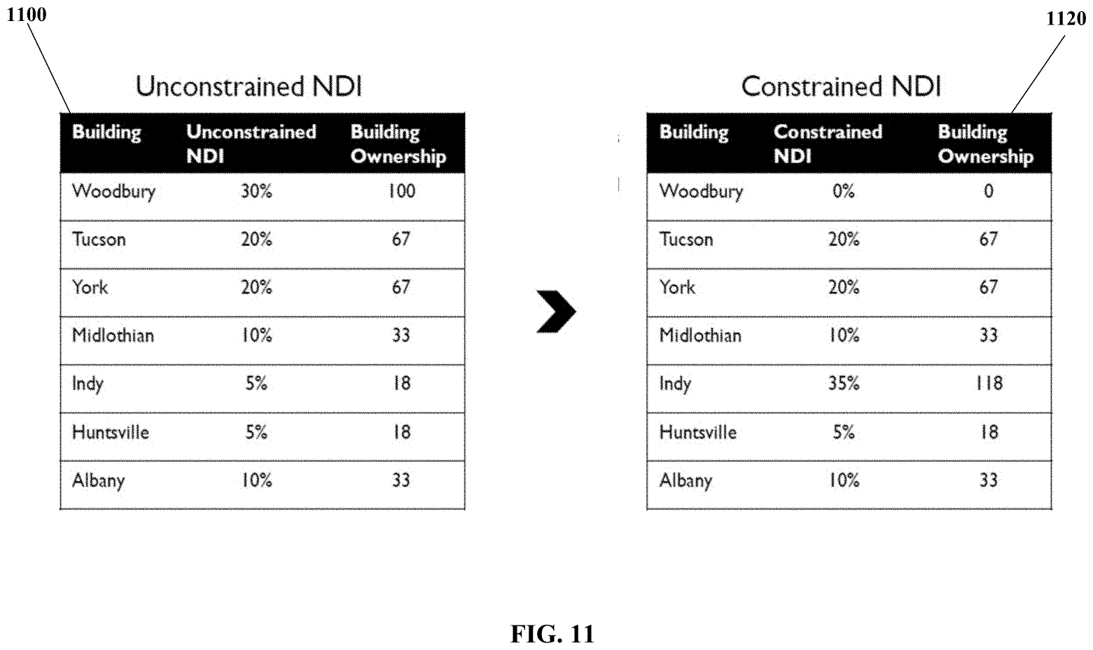

It is noted that the example tables 700, 800, 900, 1100, and 1120 (illustrated and described in FIG. 11) may be maintained by the various services described above for generation of DPA plans, and may be maintained in a common database or distributed across a computing platform having a plurality of accessible data sources connected via a network server.

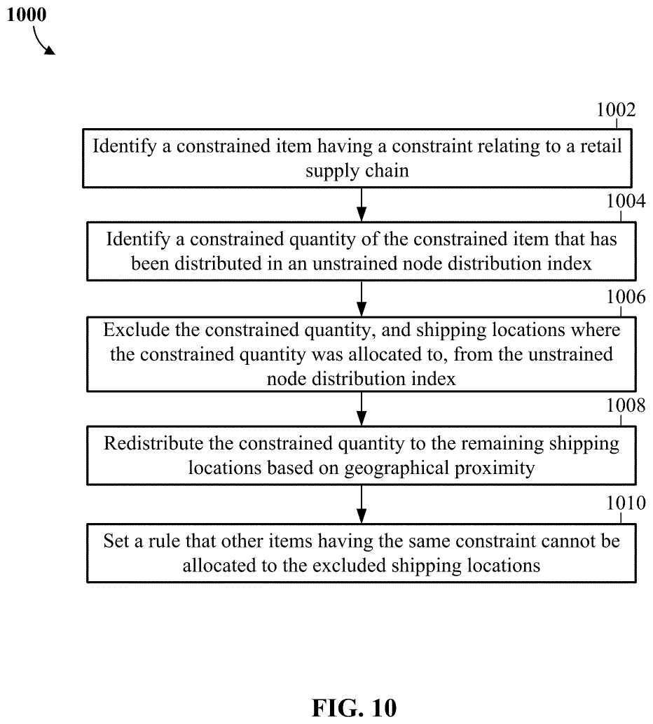

FIG. 10 is a flow chart illustrating an example method 1000 for generating a constrained node distribution index (described in FIG. 3 and FIG. 4). In some examples, the example method 1000 is performed by the next-best-node service 410 (illustrated and described in FIG. 4). As illustrated in FIG. 10, the example method 1000 includes steps 1002, 1004, 1006, 1008, and 1010.

In the example shown, the method 1000 includes identifying a constrained item having a constraint relating to a retail supply chain (step 1002). For instance, a constraint exists when a certain item is too bulky or too heavy to be processed at, stored at, or shipped to/from certain shipping locations. The method 1000 further includes identifying a constrained quantity of the constrained item that has been already distributed in an unstrained node distribution index (step 1004). For instance, when a certain quantity of the constrained item has been distributed to shipping locations that cannot process the constrained item, such distributed quantity is identified in preparation of resolving the constraint.

In the example shown, the method 1000 further includes excluding the constrained quantity, and the constrained shipping locations where the constrained quantity was allocated to, from the unstrained node distribution index (step 1006). The method 1000 further includes redistributing the constrained quantity of the constrained item to be remapped to the remaining shipping locations based on geographical proximity (step 1008). For instance, location identifiers like ZIP codes can be used to determine the geographical proximity.

In some examples, the method 1000 further includes setting a rule that other items having the same constraint cannot be allocated to the excluded shipping locations in future planning operations (step 1010). As such, when a constraint relating to the retail supply chain is identified and resolved, further placement of items is performed in cognizant of the resolved constraint to improve the efficiency of operations.

In some embodiments, the example method 1000 is configured to be performed iteratively because multiple constrained items having multiple constraints can exist. Also, one iteration of the example method 1000 can introduce a new constraint in the supply chain network which requires another one or more iterations of the example method 1000.

In other embodiments, the example method 1000 is configured to directly determine a constrained node distribution index based on identified constraints without first generating an unstrained node distribution index.

Referring to FIG. 11, two example tables 1100 and 1120 illustrate example results of generating a constrained node distribution index from an unconstrained node distribution index, in response to a supply chain constraint. In some embodiments, the example table 1120 can be generated from the example table 1100 by performing the example method 1000 (illustrated and described in FIG. 10). The illustrated example table 1100 shows an unconstrained node distribution index of an item, which is distributed across multiple shipping locations with a certain percentage being allocated to each of the shipping locations. When a supply chain constraint is identified that the item is too bulky and heavy to be processed in the location Woodbury, the example method 1000 is performed to redistribute the item in response to the constraint. The example table 1120 shows a resulted constrained node distribution index. As illustrated in the example table 1120, the location Woodbury is excluded as its corresponding percentage is reduced from 30% to 0%. The allocation that was mapped to Woodbury is redistributed to the location Indy, which has its percentage increased from 5% to 35%.

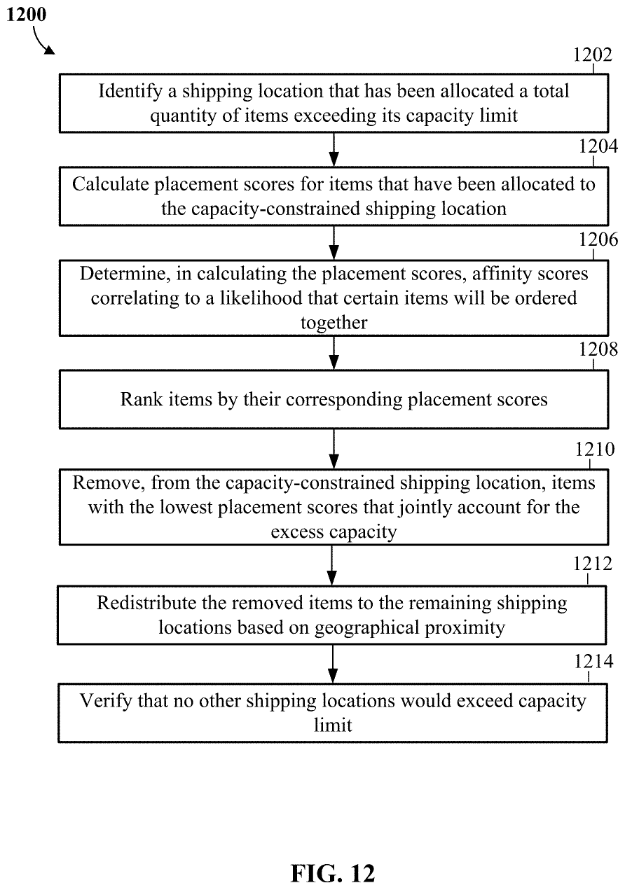

FIG. 12 is a flow chart illustrating an example method 1200 for generating a constrained node distribution index (described in FIG. 3 and FIG. 4) in response to capacity constraints of shipping locations. In some examples, the example method 1200 is performed by the next-best-node service 410 (illustrated and described in FIG. 4). As illustrated in FIG. 12, the example method 1200 includes steps 1202, 1204, 1206, 1208, 1210, 1212, and 1214.

In the example shown, the method 1200 includes identifying a shipping location that has been allocated a total quantity of items exceeding its capacity limit (step 1202). That is, the identified shipping location is capacity-constrained with a capacity constraint. The allocated excess quantity is identified in preparation of resolving the capacity constraint.

The method 1200 further includes calculating placement scores for items that have been allocated to the capacity-constrained shipping location (step 1204). Examples of the factors influencing the placement scores include the regional demand for the scored item, capacity utilization, and affinity scores correlating to a likelihood that certain items will be ordered together. In general, an item scores higher if placing the item at the capacity-constrained shipping location provides more value in terms of the efficiency of the underlying supply chain network.

In some examples, the method 1200 further includes determining the affinity scores in calculating the placement scores, the affinity scores correlating to a likelihood that certain items will be ordered together (step 1206). The affinity score for each item is evaluated in relation to every other item within a cluster of items because it is configured to increase the likelihood that items usually ordered together are stocked and shipped together.

The method 1200 further includes ranking items by their corresponding placement scores (step 1208). For instance, items can be ranked by their corresponding placement scores in an ascending order or a descending order. The method 1200 further includes removing, from the capacity-constrained shipping location, items with the lowest placement scores that jointly account for the excess capacity (step 1210). For instance, the removal process starts with the lowest scoring item and continues until the resulting inventory is reduced to just at the shipping location's capacity level. The method 1200 further includes redistributing the removed items to the remaining shipping locations based on geographical proximity (step 1212). For instance, removed items can be remapped to the next closest shipping location based on location identifiers like ZIP codes.

In some examples, the method 1200 further includes verifying that no other shipping locations would exceed capacity limit (step 1214). Other shipping locations may exceed their own capacity limits because of the previous steps of the example method 1200. By verifying as shown in the step 1214, any additional capacity constraint is identified to be resolved.

In some embodiments, the example method 1200 is configured to be performed iteratively because more capacity constraints can be introduced by performing the example method 1200 for one shipping location. Also, one iteration of the example method 1200 can introduce a new constraint in the supply chain network which requires one or more iterations of the example method 1000 (illustrated and described in FIG. 10).

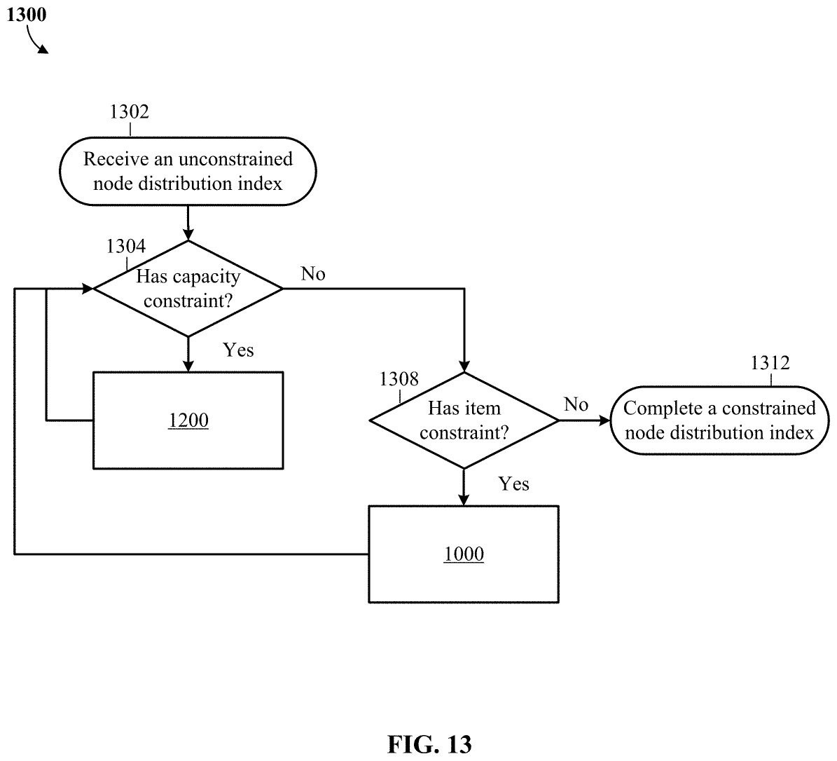

FIG. 13 is a flow chart illustrating an example method 1300 for iteratively performing the example method 1000 and the example method 1200 to solve nested and multiple constraints that can include item constraints (described in FIG. 10) and capacity constraints (described in FIG. 12). In some examples, resolving a constraint can introduce a new constraint to the supply chain network. In other examples, an item constraint and a capacity constraint can be mutually dependent on each other. As illustrated in FIG. 13, the example method 1300 includes the method 1000, the method 1200, and steps 1302, 1304, 1308, and 1312.

In the example shown, the method 1300 includes receiving an unconstrained node distribution index (step 1302). The method 1300 further includes checking whether the current distribution still has any capacity constraint for any shipping location (step 1304).

The method 1300 further includes, when the answer to the step 1304 is “yes”, performing the example method 1200 (described in FIG. 12) to resolve the capacity constraint identified by checking as shown in the step 1304. Every time that the example method 1200 is performed, the step 1304 will be rechecked until the answer to the step 1304 is “no”.

The method 1300 further includes, when the answer to the step 1304 is “no”, checking whether the current distribution still has any item constraint (step 1308).

The method 1300 further includes, when the answer to the step 1308 is “yes”, performing the example method 1000 (described in FIG. 10) to resolve the item constraint identified by checking as shown in the step 1308. Every time that the example method 1000 is performed, the step 1304 also will be rechecked until the answer to the step 1304 is “no”.

The method 1300 further includes, when both answers to the steps 1304 and 1308 are “no”, completing a constrained node distribution index (step 1312).

In other embodiments, the example method 1300 is configured to receive an unconstrained DPA plan, instead. As such, the example method 1300 is configured to output a constrained DPA plan accordingly.

In further embodiments, an optimization workflow can be integrated into the iterative processes of solving nested and multiple constraints. For instance, the optimization workflow can be based on checking space and processing power of all shipping locations. Therefore, the optimization workflow can more holistically and comprehensively distribute digital demand forecasts across the supply chain network. The optimization workflow is configured to reduce the number of iterations required to resolve nested and multiple constraints, and hence, generate constrained DPA plans more efficiently and effectively. In some examples, the optimization workflow is configured to be operated and executed on a single computing device and a single memory device. In other examples, the optimization workflow is configured to be operated and executed on a distributed computing environment comprising at least one network server, multiple computing devices, memory devices, and data storages. The network server is configured to be in communication with other components of the distributed computing environment.

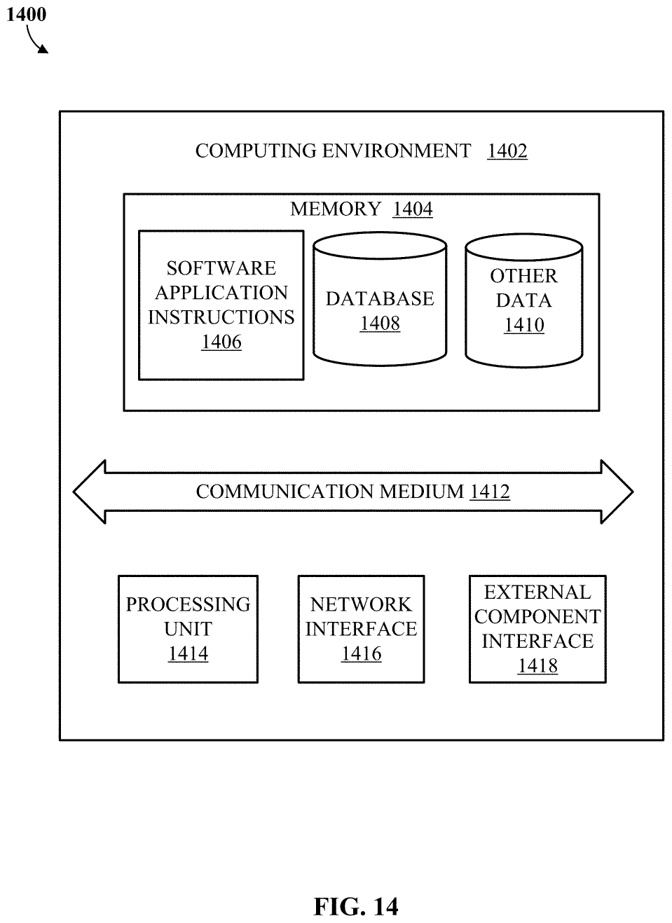

FIG. 14 illustrates an example block diagram of a virtual or physical computing system 1400. One or more aspects of the computing system 1400 can be used to implement the DPA planning system described above in conjunction with FIG. 4 and the DPA planning methods described above in conjunction with FIG. 3, FIG. 5, FIG. 6, FIG. 10, FIG. 12, or FIG. 13, within a retail enterprise having a supply chain such as illustrated in FIG. 1.

In an example, the system 1400 can include a computing environment 1402. The computing environment 1402 can be a physical computing environment, a virtualized computing environment, or a combination thereof. The computing environment 1402 can include memory 1404, a communication medium 1412, one or more processing units 1414, a network interface 1416, and an external component interface 1418.

The memory 1404 can include a computer readable storage medium. The computer storage medium can be a device or article of manufacture that stores data and/or computer-executable instructions. The memory 1404 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 1404 can store various types of data and software. For example, as illustrated, the memory 1404 includes software application instructions 1406, one or more databases 1408, as well as other data 1410.

The communication medium 1412 can facilitate communication among the components of the computing environment 1402. In an example, the communication medium 1412 can facilitate communication among the memory 1404, the one or more processing units 1414, the network interface 1416, and the external component interface 1418. The communication medium 1412 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 1414 can include physical or virtual units that selectively execute software instructions, such as the software application instructions 706. In an example, the one or more processing units 1414 can be physical products comprising one or more integrated circuits. The one or more processing units 1414 can be implemented as one or more processing cores. In another example, one or more processing units 1414 are implemented as one or more separate microprocessors. In yet another example embodiment, the one or more processing units 1414 can include an application-specific integrated circuit (ASIC) that provides specific functionality. In yet another example, the one or more processing units 1414 provide specific functionality by using an ASIC and by executing computer-executable instructions.

The network interface 1416 enables the computing environment 1402 to send and receive data from a communication network. The network interface 1416 can be implemented as an Ethernet interface, a token-ring network interface, a fiber optic network interface, a wireless network interface (e.g., Wi-Fi), or another type of network interface.

The external component interface 1418 enables the computing environment 1402 to communicate with external devices. For example, the external component interface 1418 can be a USB interface, Thunderbolt interface, a Lightning interface, a serial port interface, a parallel port interface, a PS/2 interface, or another type of interface that enables the computing environment 1402 to communicate with external devices. In various embodiments, the external component interface 1418 enables the computing environment 1402 to communicate with various external components, such as external storage devices, input devices, speakers, modems, media player docks, other computing devices, scanners, digital cameras, and fingerprint readers.

Although illustrated as being components of a single computing environment 1402, the components of the computing environment 1402 can be spread across multiple computing environments 1402. For example, one or more of instructions or data stored on the memory 1404 may be stored partially or entirely in a separate computing environment 1402 that is accessed over a network.

Depending on the size and scale of the computing environment 1402, it may be advantageous to include one or more load balancers to balance traffic across multiple physical or virtual machine nodes. In an example, the node balancer may be a node balancer product provided by F5 NETWORKS, INC. of Seattle, Washington.

Aspects of the platform 1400 and the computing environment 1402 can be protected using a robust security model. In an example, users may be made to sign into the system using a directory service, such as ACTIVE DIRECTORY by MICROSOFT CORPORATION of Redmond, Washington. Connection and credential information can be externalized from jobs using an application programming interface. Credentials can be stored in an encrypted repository in a secured operational data store database space. Privileges can be assigned based on a collaboration team and mapped to a Lightweight Directory Access Protocol (LDAP) Group membership. A self-service security model can be used to allow owners to assign others permissions on their objects (e.g., actions).

Each node may be configured to be capable of running the full platform 1400, such that portal can run and schedule jobs and serve the portal user interface as long as a single node remains functional. The environment 1402 may include monitoring technology to determine when a node is not functioning so an appropriate action can be taken.

Referring to FIGS. 1-14 generally, and according to some examples, methods for generating DPA plans are described. An example method includes receiving, from a demand forecasting system, digital demand forecasts for at least one item. The example method further includes determining a distribution of the item among a plurality of shipping locations by aggregating the digital demand forecasts based on a plurality of location identifiers, wherein the plurality of shipping locations include a plurality of warehouse locations and a plurality of retail locations. The example method further includes determining, via a model, a ratio of a first quantity of the item to a second quantity of the item, the first quantity of the item being configured to be allocated to the plurality of warehouse locations and the second quantity of the item being configured to be allocated to the plurality of retail locations, wherein the model is based on at least a first pattern of the item being ordered together with at least another item and a second pattern of the item being ordered at a certain speed. The example method further includes projecting a total quantity for the item, generating a plan for placing and allocating the total quantity of the item with the distribution and the ratio, and automatically sending the plan to a plan executor, the plan executor being configured to automatically initiate movements of at least a portion of the total quantity of the item among the plurality of shipping locations in accordance with the plan within a retail supply chain.

In other examples, the model is generated by aggregating historical sales data of a plurality of items including the item, the historical sales data being grouped based on a plurality of item types. Generating the model may include clustering, with a clustering algorithm, the historical sales data based on the first pattern and the second pattern regarding the plurality of items. Generating the model may further include labeling the historical sales data with a time identifier, and generating order profile forecasts for each of the plurality of items from the historical sales data using a time series algorithm. Determining the distribution of the item may include organizing the digital demand forecasts by at least one level of hierarchy relating to the item.

In further examples, the example method further includes identifying at least one constrained item that has at least one constraint relating to the retail supply chain, and generating, in response to the constraint, a constrained distribution of the constrained item among the plurality of shipping locations from an unconstrained distribution of the constrained item. In response to the constrained distribution, a constrained plan may be generated from the plan. Automatically sending the plan may include sending the constrained plan to the plan executor, which may automatically initiate movements of at least a portion of the total quantity of the item among the plurality of shipping locations in accordance with the constrained plan within the retail supply chain. Generating the constrained distribution may include identifying a constrained quantity of the constrained item configured to be distributed to at least one constrained shipping location in response to the constraint, excluding the constrained shipping location and the constrained quantity from the unconstrained distribution of the constrained item, and redistributing the constrained quantity of the constrained item among the plurality of shipping locations except for the constrained shipping location based on the plurality of location identifiers.

In yet further examples, generating the constrained distribution may include identifying at least one capacity-constrained shipping location, which has a capacity less than an aggregated quantity of a plurality of items configured to be distributed to the capacity-constrained shipping location in unconstrained distributions of the plurality of items. A plurality of placement scores, each of which corresponds to one of the plurality of items with respect to the capacity-constrained shipping location, may be calculated. The plurality of items may be ranked by the plurality of placement scores. Generating the constrained distribution may further include removing a lowest ranking portion of the plurality of items from the capacity-constrained shipping location having a combined quantity that equals to an excess capacity of the capacity-constrained shipping location, excluding the capacity-constrained shipping location from the unconstrained distributions of the plurality of items, and redistributing, based on the plurality of location identifiers, the combined quantity of the lowest ranking portion of the plurality of items among the plurality of shipping locations except for the capacity-constrained shipping location. A plurality of affinity scores may be calculated, each of the plurality of affinity scores correlating to a likelihood of one of the plurality of items being ordered together with at least another one of the plurality of items. The plurality of placement scores may be updated in response to the plurality of affinity scores. Various example methods of generating the constrained distribution may be performed in any combination together or iteratively.

According to some examples, systems for planning placement and allocation are described. An example system includes an input device, a database, a data processing device in communication with the database, and an output device. The data processing device is configured to receive, from the input device, digital demand forecasts for at least one item. The data processing device is further configured to determine a distribution of the item among a plurality of shipping locations by aggregating the digital demand forecasts based on a plurality of location identifiers, wherein the plurality of shipping locations include a plurality of warehouse locations and a plurality of retail locations. The data processing device is further configured to determine, via a model, a ratio of a first quantity of the item to a second quantity of the item, the first quantity of the item being configured to be allocated to the plurality of warehouse locations and the second quantity of the item being configured to be allocated to the plurality of retail locations, wherein the model is based on at least a first pattern of the item being ordered together with at least another item and a second pattern of the item being ordered at a certain speed. The data processing device is further configured to project a total quantity for the item, generate a plan for placing and allocating the total quantity of the item with the distribution and the ratio, and automatically send, using the output device, the plan to a plan executor, the plan executor being configured to automatically initiate movements of at least a portion of the total quantity of the item among the plurality of shipping locations in accordance with the plan within a retail supply chain.

In other examples, the data processing device is further configured to aggregate historical sales data of a plurality of items to generate the model, the historical sales data being grouped based on a plurality of item types. The historical sales data may be clustered using a clustering algorithm based on the first pattern and the second pattern regarding the plurality of items. The historical sales data may be labeled with a time identifier. The data processing device may be further configured to generate order profile forecasts for each of the plurality of items from the historical sales data using a time series algorithm. The data processing device may be further configured to store the distribution, the ratio, and the total quantity of the item in the database, retrieve the distribution, the ratio, and the total quantity of the item for generating the plan from the database, and store the plan in the database. The data processing device may be further configured to store the historical sales data and the order profile forecasts in the database.

In further examples, the data processing device is further configured to receive, from the input device, information about at least one constrained item, the constrained item having at least one constraint relating to the retail supply chain. The data processing device may generate, in response to the constraint, a constrained distribution of the constrained item among the plurality of shipping locations from an unconstrained distribution of the constrained item. The data processing device may further store the constrained distribution in the database, generate a constrained plan from the plan in response to the constrained distribution, and automatically send, using the output device, the constrained plan to a plan executor that may automatically initiate movements of at least a portion of the total quantity of the item among the plurality of shipping locations in accordance with the constrained plan within the retail supply chain.

According to some examples, platforms for planning placement and allocation are described. An example platform includes a first and second computing devices, a plurality of data storages, and a network server in communication with the plurality of data storages, and with the first and second computing devices. The first computing device is configured to receive, from the network server, digital demand forecasts for at least one constrained item and information about the constrained item, the constrained item having at least one constraint relating to a retail supply chain. The first computing device is further configured to determine, in response to the constraint, a constrained distribution of the constrained item among a plurality of shipping locations by aggregating the digital demand forecasts based on a plurality of location identifiers, wherein the plurality of shipping locations include a plurality of warehouse locations and a plurality of retail locations. The first computing device is further configured to determine, via a model, a ratio of a first quantity of the constrained item to a second quantity of the constrained item, the first quantity of the constrained item being configured to be allocated to the plurality of warehouse locations and the second quantity of the constrained item being configured to be allocated to the plurality of retail locations, wherein the model is based on at least a first pattern of the constrained item being ordered together with at least another item and a second pattern of the constrained item being ordered at a certain speed. The first computing device is further configured to project a total quantity for the constrained item, generate a constrained plan for placing and allocating the total quantity of the constrained item with the constrained distribution and the ratio, and automatically send, via the network server, the constrained plan to the second computing device, the second computing device being configured to automatically initiate movements of at least a portion of the total quantity of the constrained item among the plurality of shipping locations in accordance with the constrained plan within a retail supply chain.

In other examples, the second computing device is configured to receive, from the network server, digital demand forecasts for at least one item. The second computing device may determine a distribution of the item among a plurality of shipping locations by aggregating the digital demand forecasts based on a plurality of location identifiers, wherein the plurality of shipping locations include a plurality of warehouse locations and a plurality of retail locations. The second computing device may further determine, via a model, a ratio of a first quantity of the item to a second quantity of the item, the first quantity of the item being configured to be allocated to the plurality of warehouse locations and the second quantity of the item being configured to be allocated to the plurality of retail locations, wherein the model is based on at least a first pattern of the item being ordered together with at least another item and a second pattern of the item being ordered at a certain speed. The second computing device may further project a total quantity for the item, generate a plan for placing and allocating the total quantity of the item with the distribution and the ratio, receive information about the constrained item from the first computing device via the network server, and generate the constrained plan from the plan in response to the constraint. The second computing device may further initiate movements of at least a portion of the total quantity of the item among the plurality of shipping locations in accordance with the constrained plan within the retail supply chain.

In further examples, the first computing device is further configured to store the constrained plan in one of the plurality of data storages via the network server. The second computing device may be further configured to store the plan and the constrained plan in one of the plurality of data storages via the network server. The second computing device may further store, via the network server, the plan in a first one of the plurality of data storages and the constrained plan in a second one of the plurality of data storages.

The above specification, examples and data provide a complete description of the manufacture and use of the composition of the invention. Since many embodiments of the invention can be made without departing from the spirit and scope of the invention, the invention resides in the claims hereinafter appended.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method comprising:
receiving, from a demand forecasting system, digital demand forecasts for at least one item;
determining a distribution of the item among a plurality of shipping locations by aggregating the digital demand forecasts based on a plurality of location identifiers, wherein the plurality of shipping locations include a plurality of warehouse locations and a plurality of retail locations;
determining, via a model, a ratio of a first quantity of the item to a second quantity of the item, the first quantity of the item being configured to be allocated to the plurality of warehouse locations and the second quantity of the item being configured to be allocated to the plurality of retail locations, wherein the model is based on at least a first pattern of the item being ordered together with at least another item and a second pattern of the item being ordered at a certain speed;
projecting a total quantity for the item;
generating, with the distribution and the ratio, a plan for placing and allocating the total quantity of the item; and
automatically sending the plan to a plan executor, the plan executor being configured to automatically initiate movements of at least a portion of the total quantity of the item among the plurality of shipping locations in accordance with the plan within a retail supply chain.

2. The method of claim 1, wherein the model is generated by aggregating historical sales data of a plurality of items including the item, the historical sales data being grouped based on a plurality of item types.

3. The method of claim 2, further comprising clustering, with a clustering algorithm, the historical sales data based on the first pattern and the second pattern regarding the plurality of items.

4. The method of claim 3, further comprising:
labeling the historical sales data with a time identifier; and
generating order profile forecasts for each of the plurality of items from the historical sales data using a time series algorithm.

5. The method of claim 1, further comprising organizing the digital demand forecasts by at least one level of hierarchy relating to the item.

6. The method of claim 1, further comprising:
identifying at least one constrained item, the constrained item having at least one constraint relating to the retail supply chain;
generating, in response to the constraint, a constrained distribution of the constrained item among the plurality of shipping locations from an unconstrained distribution of the constrained item;
generating, in response to the constrained distribution, a constrained plan from the plan; and
wherein automatically sending the plan comprises sending the constrained plan to the plan executor, the plan executor being configured to automatically initiate movements of at least a portion of the total quantity of the item among the plurality of shipping locations in accordance with the constrained plan within the retail supply chain.

7. The method of claim 6, further comprising:
identifying, in response to the constraint, a constrained quantity of the constrained item configured to be distributed to at least one constrained shipping location;
excluding the constrained shipping location and the constrained quantity from the unconstrained distribution of the constrained item; and
redistributing, based on the plurality of location identifiers, the constrained quantity of the constrained item among the plurality of shipping locations except for the constrained shipping location.

8. The method of claim 6, further comprising:
identifying at least one capacity-constrained shipping location, the capacity-constrained shipping location having a capacity less than an aggregated quantity of a plurality of items configured to be distributed to the capacity-constrained shipping location in unconstrained distributions of the plurality of items;
calculating a plurality of placement scores, each of the plurality of placement scores corresponding to one of the plurality of items with respect to the capacity-constrained shipping location;
ranking the plurality of items by the plurality of placement scores;
removing a lowest ranking portion of the plurality of items from the capacity-constrained shipping location, the removed portion of the plurality of items having a combined quantity that equals to an excess capacity of the capacity-constrained shipping location;
excluding the capacity-constrained shipping location from the unconstrained distributions of the plurality of items; and
redistributing, based on the plurality of location identifiers, the combined quantity of the lowest ranking portion of the plurality of items among the plurality of shipping locations except for the capacity-constrained shipping location.

9. The method of claim 8, further comprising:
calculating a plurality of affinity scores, each of the plurality of affinity scores correlating to a likelihood of one of the plurality of items being ordered together with at least another one of the plurality of items; and
updating the plurality of placement scores in response to the plurality of affinity scores.

10. The method of claim 8, further comprising:
identifying, in response to the constraint, a constrained quantity of the constrained item configured to be distributed to at least one constrained shipping location;
excluding the constrained shipping location and the constrained quantity from the unconstrained distribution of the constrained item; and
redistributing, based on the plurality of location identifiers, the constrained quantity of the constrained item among the plurality of shipping locations except for the constrained shipping location and the capacity-constrained shipping location.

11. A system for planning placement and allocation, comprising:
an input device;
a database;
a data processing device in communication with the database; and
an output device,
wherein the data processing device is configured to:
receive, from the input device, digital demand forecasts for at least one item;
determine a distribution of the item among a plurality of shipping locations by aggregating the digital demand forecasts based on a plurality of location identifiers, wherein the plurality of shipping locations include a plurality of warehouse locations and a plurality of retail locations;
determine, via a model, a ratio of a first quantity of the item to a second quantity of the item, the first quantity of the item being configured to be allocated to the plurality of warehouse locations and the second quantity of the item being configured to be allocated to the plurality of retail locations, wherein the model is based on at least a first pattern of the item being ordered together with at least another item and a second pattern of the item being ordered at a certain speed;
project a total quantity for the item;
generate, with the distribution and the ratio, a plan for placing and allocating the total quantity of the item; and
automatically send, using the output device, the plan to a plan executor, the plan executor being configured to automatically initiate movements of at least a portion of the total quantity of the item among the plurality of shipping locations in accordance with the plan within a retail supply chain.

12. The system of claim 11, wherein the data processing device is further configured to:
aggregate historical sales data of a plurality of items to generate the model, the historical sales data being grouped based on a plurality of item types;
cluster, with a clustering algorithm, the historical sales data based on the first pattern and the second pattern regarding the plurality of items;
label the historical sales data with a time identifier; and
generate order profile forecasts for each of the plurality of items from the historical sales data using a time series algorithm.

13. The system of claim 11, wherein the data processing device is further configured to:
store the distribution, the ratio, and the total quantity of the item in the database;
retrieve, from the database, the distribution, the ratio, and the total quantity of the item for generating the plan; and
store the plan in the database.

14. The system of claim 12, wherein the data processing device is further configured to store the historical sales data and the order profile forecasts in the database.

15. The system of claim 11, wherein the data processing device is further configured to:
store the distribution and the plan in the database;
receive, from the input device, information about at least one constrained item, the constrained item having at least one constraint relating to the retail supply chain;
generate, in response to the constraint, a constrained distribution of the constrained item among the plurality of shipping locations from an unconstrained distribution of the constrained item;
store the constrained distribution in the database;
generate, in response to the constrained distribution, a constrained plan from the plan; and
automatically send, using the output device, the constrained plan to the plan executor, the plan executor being configured to automatically initiate movements of at least a portion of the total quantity of the item among the plurality of shipping locations in accordance with the constrained plan within the retail supply chain.

16. A platform for planning placement and allocation, comprising:
a first and second computing devices;
a plurality of data storages; and
a network server in communication with the plurality of data storages, and with the first and second computing devices,
wherein the first computing device is configured to:
receive, from the network server, digital demand forecasts for at least one constrained item and information about the constrained item, the constrained item having at least one constraint relating to a retail supply chain;
determine, in response to the constraint, a constrained distribution of the constrained item among a plurality of shipping locations by aggregating the digital demand forecasts based on a plurality of location identifiers, wherein the plurality of shipping locations include a plurality of warehouse locations and a plurality of retail locations;
determine, via a model, a ratio of a first quantity of the constrained item to a second quantity of the constrained item, the first quantity of the constrained item being configured to be allocated to the plurality of warehouse locations and the second quantity of the constrained item being configured to be allocated to the plurality of retail locations, wherein the model is based on at least a first pattern of the constrained item being ordered together with at least another item and a second pattern of the constrained item being ordered at a certain speed;
project a total quantity for the constrained item;
generate, with the constrained distribution and the ratio, a constrained plan for placing and allocating the total quantity of the constrained item; and
automatically send, via the network server, the constrained plan to the second computing device, the second computing device being configured to automatically initiate movements of at least a portion of the total quantity of the constrained item among the plurality of shipping locations in accordance with the constrained plan within a retail supply chain.

17. The platform of claim 16, wherein the second computing device is configured to:
receive, from the network server, digital demand forecasts for at least one item;
determine a distribution of the item among a plurality of shipping locations by aggregating the digital demand forecasts based on a plurality of location identifiers, wherein the plurality of shipping locations include a plurality of warehouse locations and a plurality of retail locations;
determine, via a model, a ratio of a first quantity of the item to a second quantity of the item, the first quantity of the item being configured to be allocated to the plurality of warehouse locations and the second quantity of the item being configured to be allocated to the plurality of retail locations, wherein the model is based on at least a first pattern of the item being ordered together with at least another item and a second pattern of the item being ordered at a certain speed;
project a total quantity for the item;
generate, with the distribution and the ratio, a plan for placing and allocating the total quantity of the item;
receive, from the first computing device via the network server, information about the constrained item;
generate, in response to the constraint, the constrained plan from the plan; and
initiate movements of at least a portion of the total quantity of the item among the plurality of shipping locations in accordance with the constrained plan within the retail supply chain.

18. The platform of claim 16, wherein the first computing device is further configured to store the constrained plan in one of the plurality of data storages via the network server.

19. The platform of claim 17, wherein the second computing device is further configured to store the plan and the constrained plan in one of the plurality of data storages via the network server.

20. The platform of claim 17, wherein the second computing device is further configured to store, via the network server, the plan in a first one of the plurality of data storages and the constrained plan in a second one of the plurality of data storages.
